(19) United States
(12) Patent Application Publication
(10) Pub. No.: US 2002/0073111 A1
(43) Pub. Date: Jun. 13, 2002

(54) Computer software system and method to expedite data entry for databases

(76) Inventor: David Kern Heyliger, Glenwood Springs, CO (US)

Correspondence Address: Dave Heyliger, 0116 Deer Park Court, Glenwood Springs, CO, 81601, US

(21) Appl. No.: 09/894,202

(22) Filed: Jun. 27, 2001

Related U.S. Application Data
(60) Provisional application No. 60/214,526, filed on Jun. 27, 2000.
(60) Provisional application No. 60/239,803, filed on Oct. 11, 2000.

(51) Int. Cl. G06F 15/00; G09G 5/00; G06F 17/00; G06F 17/21; G06F 17/24

(52) U.S. Cl. 707/500; 345/781

(57) ABSTRACT

A computer software system and method of enhanced data collection, manipulation, and management of information that is to be contained on a database located on a central server. The method is performed via a software application running on one or more computer workstations located in one or more locations. The method is both expedited and simplified by providing powerful data manipulation and data generation routines that are executed during data entry or after the data is contained within the database. The method may also manage to track the status of each data item entered at the computer workstation, and also the current state of the item, which could be either online, offline, suspended, needs removing, or needs uploading. In addition, the method may also include a preset expiration mechanism. This mechanism is based on elapsed time, and will automatically change the state of any item from “online” to “offline” if no modifications are performed on the item during the defined time span. Finally, the method may also enable the data collection and manipulation process to expand over two or more sessions, replacing the current industry-standard online data collection methodology of accepting only completed data entry sessions in real-time.

### FIELD OF THE INVENTION

This invention relates to a stand-alone digital image and text-based data collection and management software application that expedites and simplifies data entry, digital image manipulation, and data expiration before submitting the information to a central database.

### BACKGROUND OF THE INVENTION

Certain online web sites have a very dynamic inventory that changes rapidly over a relatively short period of time. Some examples include automobile sites, real estate sites, animal shelters/pet rescue sites, “mega” mall sites, lost & found sites, and public auction sites. On each of these sites, the content and availability of inventory varies from day-today, if not hour-to-hour. The informational data components that comprise the inventory (homes, cars, equipment, pets, etc.) on these sites must include both a digital image and some text, since potential online shoppers demand to both see and read about an inventory item. Without both the digital image and the text components, the online site fails.

However, obtaining a digital image and also entering in the specifics of each item in inventory is a time consuming task. It may also require that the data entry person possess certain skills.

For example, if the online site is to be successful, the digital image presentation should be predictable and uniform. This means that the digital images must be centered, cropped, and massaged to specifications, which usually includes a set height and width. This task is beyond the scope for the average data entry person - unless they have had experience with digital image manipulation.

The text-based component requires data entry, and in certain industries this data entry includes one or more item-specific text-based descriptive paragraphs (e.g. “This lovely 4-bedroom home has . . . ” or “This immaculate Ford 4×4 . . . ”). These descriptive phrases further add to the burden of data collection, and require the individual entering the data to be somewhat creative, since they are forced into writing a short composition.

In certain industries, various data components describing the current inventory may already exist in an industry-specific third party application. For example, the automobile, real estate, and animal rescue industries all may use existing third party database management software to track their inventory. However, these third party software applications do not contain the appropriate data manipulation and data generation mechanisms that automate sentence composition, and they do not provide an intuitive digital photo manipulation mechanism. This means that even though the data may exist in a digital format, a skilled person must still pre-process the information prior to posting it online.

Data collection methods vary from site-to-site. In some situations—for example, a local car dealership—the data entry session can be done via a single individual and possibly even at the location of the central server. However, in wide-area distributed situations—such as a national online real estate site or a national online pet shelter site - the current method of data entry cannot be performed “in-house” or by a single individual, since the data content exists over a large distributed area. For these types of sites, the data collection method is performed either via an online session, email, or similar piecemeal mechanisms.

Online data entry sessions include fairly “clunky” and archaic input mechanisms, comprised of Internet-based web page forms containing input fields, radio buttons, checkboxes and drop-down lists. These sessions also typically do not contain any digital image manipulation mechanisms whatsoever. In addition, failure to complete the entire online data entry process for a given item in inventory causes the partially entered inventory item to be discarded. This means that if the data entry person loses their connection during data entry, all their data for a specific item becomes lost, and they must repeat the data entry process.

Email updating has similar problems: they too are “clunky” and non-uniform. The format of the email may or may not be standardized, which could force re-processing each submission “by hand” before database insertion. These submissions also require external digital image manipulation—usually via a third party software application—before sending the digital image information as an attachment. The digital image may or may not be in the correct size and/or format desired due to the lack of control and a standardized input mechanism.

In addition, inventory management with respect to time is also difficult when the inventory is spread out over a very large area. Certain industry-related items such as cars, pets, and homes, may not actually be available—especially a few days or weeks after submission. In other words, the online database may not actually reflect the exact content of the available items.

Finally, in order for an individual to verify that the data they entered is indeed in the online database requires them to connect to the server and perform an online search. There is no method or tracking mechanism other than the database itself to verify the online status of any given item in inventory.

Therefore, due to the above inherent issues of data collection for online databases, it would be desirable to provide a mechanism that would standardize and expedite the data input, (optional) data importing, and data verification process of dynamic inventory items that include both a digital image and text for database insertion. It would also be desirable to provide a means by which an “average person” with little or no computer skills could successfully perform said data entry without obtaining additional training and/or expertise.

### SUMMARY OF THE INVENTION

Accordingly, it is an object of the invention to expedite the time-consuming process of inventory data entry for a database that includes both a digital image and text.

It is also an object of the invention to provide a mechanism by which an average user with little or no computer skills could perform said data entry.

Another object of the invention is to provide a quick and easy method of digital image manipulation that centers, crops, and massages a digital image of the inventory item to a fixed-sized digital image suitable for presentation without any prior digital image manipulation experience.

Another object of the invention is to optionally remove the requirement of a unique digital image of the item by providing a mechanism that specifies to the database to use a “default image” that is already contained within the database.

A further object of the invention is to automatically produce one or more text-based descriptive paragraphs based on data entry and optional interface components, thus eliminating the process of composing the descriptions “by hand”, and eliminating the restriction that the data entry person must posses a certain “creative” ability.

Yet another object of the invention is to optionally leverage data contained in an industry standard third party database by providing a data import method that obtains the desired existing information prior to any automated data manipulation and/or digital photo manipulation.

Another object of the invention is to maintain the current editing state of the data and to allow for temporary partial input, thus eliminating the loss of data entry that occurs with real-time online data entry.

Another object of the invention is to provide a data tracking method of the current state of an item without going online to obtain the item's state, including both the item's information (text and digital image) and the status of the item (online, offline, suspended, needs removing, or needs updating).

A further object of the invention includes an expiration date for each new or updated item that is generated automatically based off of time (days, weeks, months) from the initial item insertion or modification date. This date is then used to change the state of an item from “online” to “offline” and possibly remove of the “offline” item—if no modifications are performed on the item during the defined time span.

Still another object of the invention is to expedite inventory item creation and modification by allowing one to enter, modify, manipulate and/or edit an item without going online to obtain the information of item to be modified.

Yet another object of the invention is to provide a “one-click” or time-activated database updating method via a workstation, thus expediting the database updating process while at the same time eliminating the “clunky” online data entry methodology.

These and other objects are achieved by providing a computer software system and method that allows one with little or no skills to quickly enter and/or import text and manipulate digital images of an inventory item, and then transmit the data to a database automatically or via a single click of the mouse. The computer software system and method may also allow one to capture or import, then center, size, and crop a digital image to meet certain size specifications—thus rendering the image suitable for online presentation—within seconds and by a user with no prior digital image editing experience. It also provides a mechanism that allows one to bypass the digital image manipulation process completely, and instead, specify that the database use a pre-defined “default image” for the inventory item. It also provides an optional data import mechanism that may be used to obtain much of the existing inventory information from an existing third party database prior to enhanced data manipulation and/or digital photo manipulation. It also provides a mechanism for automatic descriptive paragraph generation based upon data entry I data import components. This computer software system and method may also track the state of each inventory item to provide instant verification and possible modification of the data and/or status without having to first go online to do so.

### BRIEF DESCRIPTION OF THE DRAWINGS

FIG. 1 shows the interface of the database component of the software application;

FIG. 1A shows the data import interface component of the software application,

FIG. 2 shows the interface of the workstation component of the software application;

FIG. 3 show the interface of the Internet upload component of the software application;

FIG. 4 shows the first initial phase of how the digital photo manipulation mechanism of the software application works: the upper-left corner of the photo to be manipulated is initially placed at position (0,0) of the viewport;

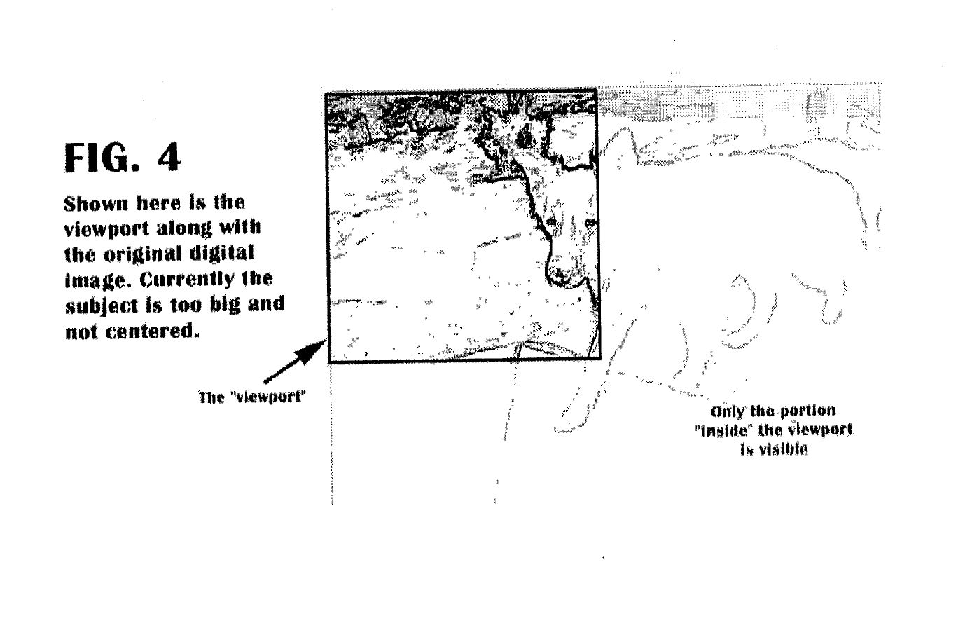

FIG. 5 shows how a mouse (or pointing device) “drag” action on the digital photo moves the image within the viewport and allows the subject of the image to be centered within seconds;

FIG. 6 shows how the “shrink” action reduces the overall size of the image within the viewport;

FIG. 7 shows the photo manipulation component of the software, including the viewport that currently contains an image of a dog, the buttons that allow the image to be digitally enhanced just by clicking them, and the instructions;

FIG. 8 shows how the application indicates that a default image will be used unless specified otherwise;

FIG. 9 shows how the software may optionally display the actual default image that will be used for the inventory item if no actual image is specified;

FIG. 10 shows the automatic story generation component of the software;

FIG. 11 is a flowchart showing the operation of the software application;

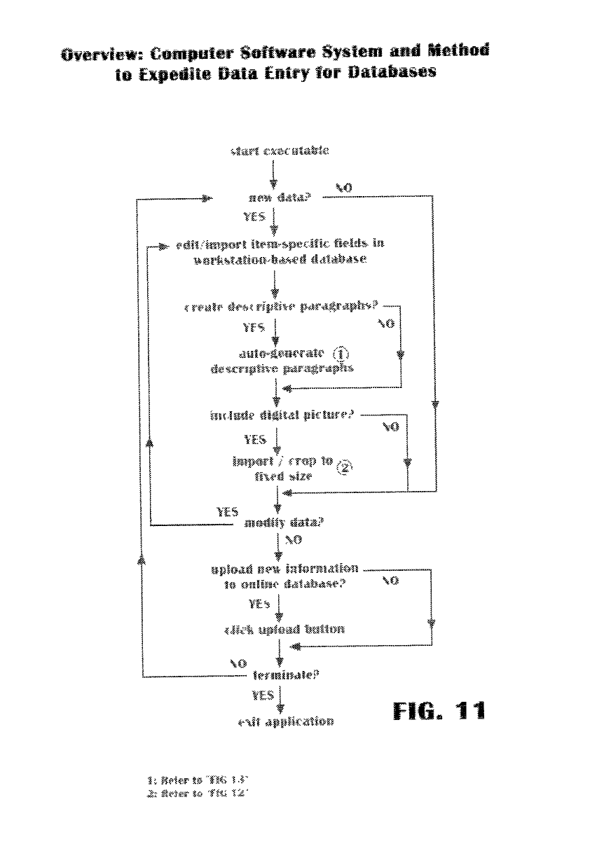

FIG. 12 is a flowchart showing the operation of the digital manipulation mechanism of the software application;

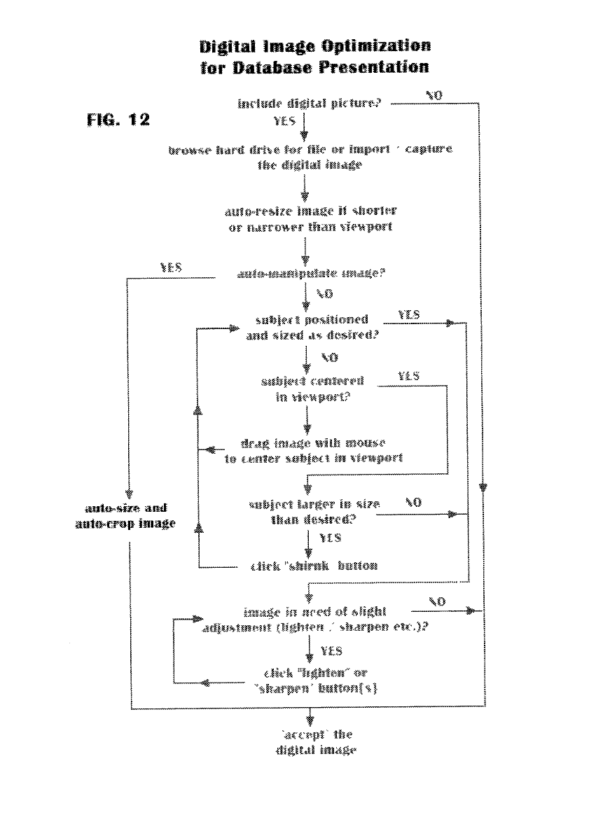

FIG. 13 is a flowchart showing the operation of the automatic story generation mechanism of the software application;

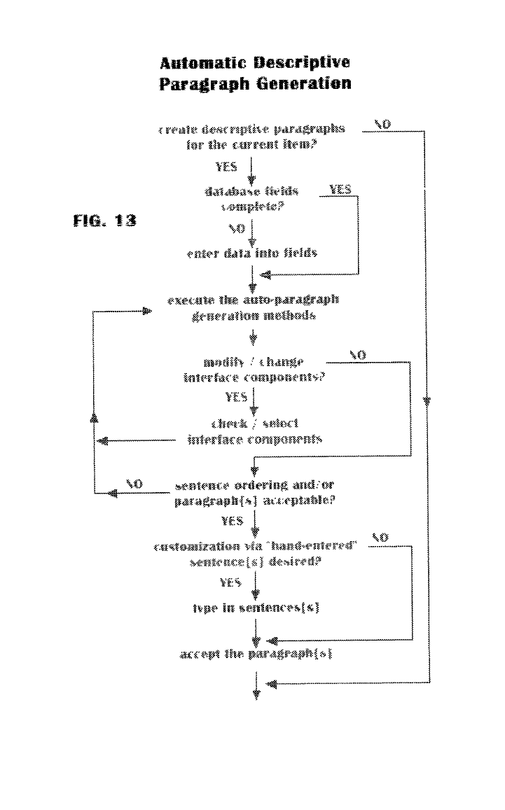

### DETAILED DESCRIPTION OF THE INVENTION

It is important to understand that a “central server” might be used to display the database contents and/or be used to computer-generate one or more phrases based off of the database contents in real time, and then display these items via the World Wide Web. In doing so, it is advantageous that the digital image components of the content be of a set size (height and width) and format (like a JPG or GIF) if the HTML web pages to be both designed and properly displayed. This advantage should be kept in mind throughout this disclosure.

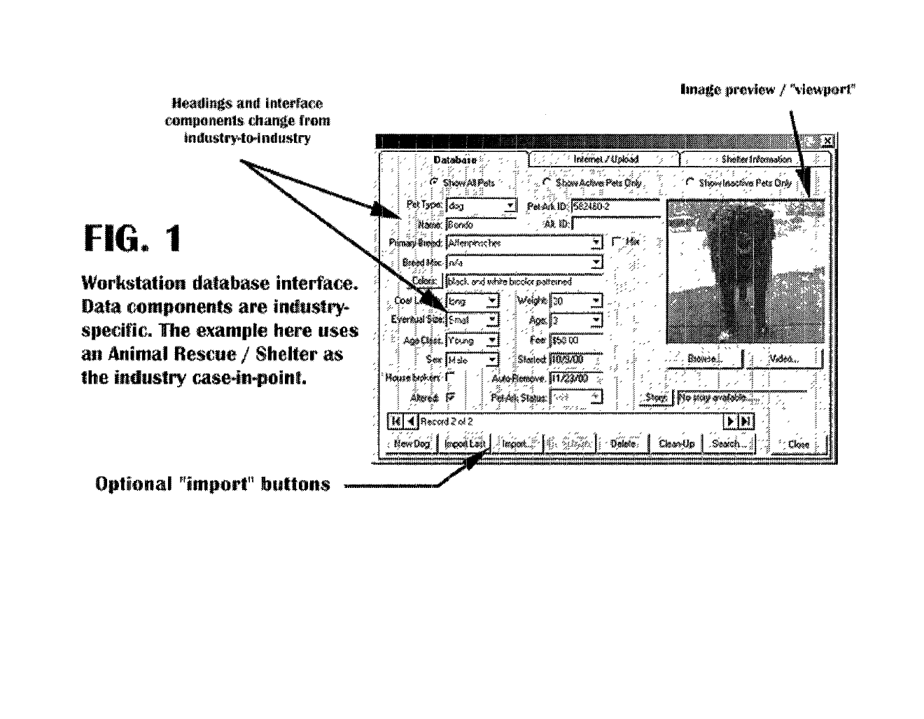

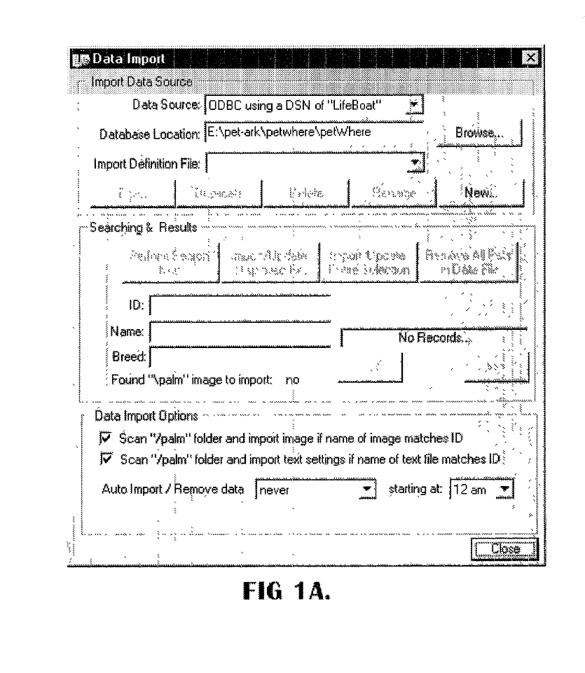

The invention includes a GUI (graphical user interface) software application that is executed on a computer workstation located anywhere. The minimum computer workstation configuration might include—for example—an Intel Pentium based PC with a 500-megabyte hard disk drive, 16 megabytes of RAM, a monitor, a pointing device, keyboard, and an Internet connection. Any other computer of a similar capacity would suffice as the “computer workstation”, including—for example—a hand-held “palm pilot” computer (PDA) with optional digital image capture capability and no Internet connection. Many variations on the hardware exist. The software application may exist as a stand-alone executable (written in Visual Basic or a similar programming language), exist as a server-based application (written in Java or a similar programming language), exist on a hand-held computer (written in C, C++, or a similar programming language), or exist as a combination thereof. The software application maintains a local database (a database located on the workstation's hard drive, internal memory, or a database located on another workstation on a local area network) that contains all the information about every item entered at the specific computer workstation. This information includes descriptive information about the item, an optional corresponding digital image, the status of the information (online, offline, etc.), and an optional preset expiration date for the item if the item remains unchanged. Refer to FIG. 1.

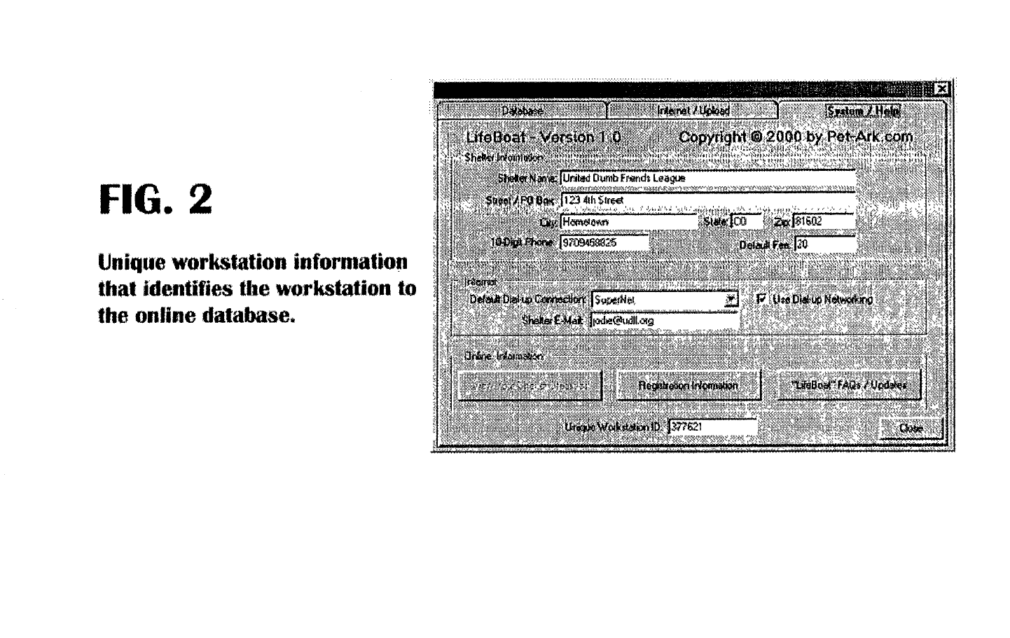

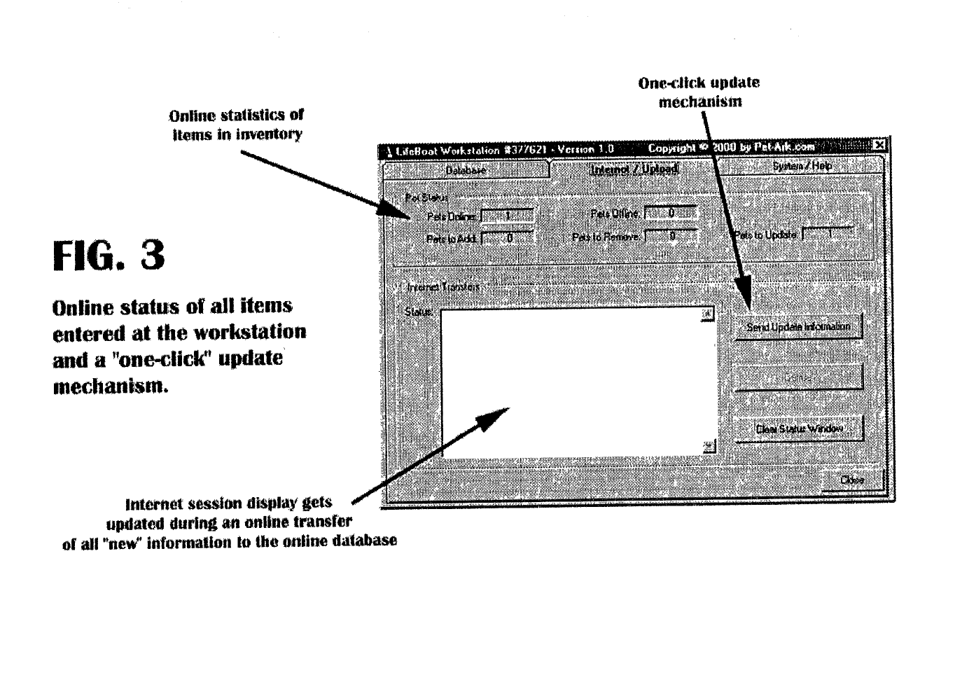

In addition to the information listed above, the local database may also contain information about the specific workstation, including but not limited to, the location, address, and phone number where the workstation resides. It may include additional information such as a contact name, contact email address, and additional descriptors. It may also contain a unique workstation ID number assigned to the workstation via the software application. The ID number may be used to identify the workstation to a local or remote server when an update is performed. Refer to FIG. 2. The application may also maintain the current online database status of all entered items, which includes online, offline, suspended, needs removing, or needs updating. These status values mirror the actual status of the data on the “central server”. It may also contain a mechanism by which a single click or timer expiration will transmit any or all “new” information to the central server for database insertion. Refer to FIG. 3.

The application allows one to manipulate existing information and/or input I import new information about an item via input fields, drop-down lists, checkboxes and/or radio buttons. These components are designed such to reflect the given industry: all the fields, lists, checkboxes and radio buttons would contain data that would expedite the entry process. For example, if the invention was geared towards the automobile industry, a certain drop-down list might include the car classification (compact, sub-compact, SUV, luxury, etc.). Similarly, if the software was geared towards the real estate industry, a certain drop-down list might include the style of home (condo, townhouse, mobile home, estate, etc.). For demonstration purposes, FIG. I shows a typical example that could be used for the Animal Rescue/Shelter industry.

The computer software system and method includes these basic components:

1. A data collection and manipulation component that allows items to be imported, added, edited, removed, suspended, etc.

2. An item state and status component that mirrors the item's information as it exists on the “central server” (its state), and also tracks the item's status (online, offline, suspended, needs removing, needs uploading)

3. And an automated data transmission component that allows the end-user at the workstation to update the “central server” database with either “just one click”, or automatically after a certain time interval has expired.

The data collection and manipulation component of the invention allows a user running the software on a workstation located anywhere to

1. input text-based information of an item in inventory via input fields, radio buttons, drop-down boxes and similar user interface components

2. optionally bypass much of the data entry of (1) above by importing information that already exists in a third party database via an “import button” (FIG 1A)

3. optionally import and/or capture and then quickly manipulate a corresponding digital image—including centering, cropping, and tuning the image such that it is suitable for online presentation (correct size, height, width, and quality)—within seconds and without any special skills or talents OR

4. optionally import an existing digital image of the inventory item and have the image “auto-cropped” and “auto-manipulated” such that the imported image is suitable for online posting (correct size, height, width, and quality) without the user ever interacting with the image OR

5. optionally bypass the digital image manipulation process, thus indicating to the online database to use a pre-existing “default image” located online, and also

6. automatically generate a text-based description (or “story”) about the item based off of data from (1) above and perhaps from some additional industry-specific interface option selections—without any special skills or talents

The item state and status component of the invention allows a user running the software on a workstation located anywhere to

1. examine the text and digital image information of the item in inventory as it exists on the “central server” without ever connecting to the “central server”

2. optionally edit the text and/or digital image information without connecting to the “central server”

3. examine the current status of the item (online, offline, suspended, needs removal, needs uploading)

4. optionally edit the status of the item (e.g., changing the status from “suspended” to “update”)

The automated data transmission component of the invention allows a user running the software on a workstation located anywhere to

1. click a single button located on the software's user interface to automatically connect to the “central server” and add, update and/or remove information from the database, or

2. optionally have the software perform the above procedure automatically without interaction after a preset time interval has expired

The computer software system and method includes some unique components. Each of these unique components exist in such a manner that they could run independently of each other. These components include:

1. A unique accelerated method of digital image manipulation with respect to importing, optional capturing, sizing, cropping and fine-tuning a fixed-sized digital image

2. A unique method of providing a mechanism to inform the target database to alternatively use a pre-existing “default image” for the item in question

3. A unique method of descriptive paragraph generation based off of database fields and/or simple input options, and

4. A unique method of updating a central server database with “just one click” or via a timer.

These features are described in detail below. Please note that throughout this document, the term “mouse” could mean any type of computer pointing device, such as a track ball with buttons, a touch screen, a light pen, or similar.

Accelerated Method of Digital Image Manipulation to a Centered, Fixed Size Image

This component of the invention allows a person with very limited computer experience to expedite a digital image manipulation process, allowing one to select, optionally capture, size, crop and fine tune an image with a minimum of mouse clicks/motions. The entire process takes only but a few seconds, and always produces an optimized digital image of an exact fixed size. This component may be viewed and executed as an integral part of the entire invention, or it may exist as a separate component since it has the capability of being applied to similar related computer applications.

The software accomplishes this method by providing a fixed-sized window—or “viewport”—on the software interface. The size of the viewport (height and width) is the exact same size as the desired presentation size of the final digital image. Refer to FIG. 1, which shows a typical “viewport”.

A user may select an existing digital image by clicking a button on the interface that allows them to browse the hard drive and locate the desired digital image file. The user may optionally perform a live capture of the subject via an inexpensive digital video camera or palm computer by pressing an optional “Capture . . . ” button. Alternatively, the user may optionally choose to “import” an image contained on a hand-held “palm” computer or within digital camera—again by clicking an appropriate interface button.

The selected digital image—whether it was scanned in via a scanner, captured live, downloaded from a digital camera or palm device, downloaded from the Internet, etc.—is initially located “inside” the viewport, with the upper-left corner of the image being positioned at location (0,0) of the upper-left corner of the viewport. Refer to FIG .4.

The selected digital image is typically larger (H×W) than the size of the viewport. However, if the selected digital image is smaller than the viewport, it is initially proportionally resized automatically such that the image is at least as high and at least as wide as the dimensions of the viewport.

From this moment on, the user may at any time choose to “accept” the visible portion of the image contained within the viewport. The term “accept” here implies that a new digital image will be created and saved, where the “new image” is comprised of only the visible portion of the image loaded inside the viewport.

However, typically the image needs to be positioned and sized before it can be accepted, since the subject of the image may be off-center or the subject is too large to be completely visible within the bounds of the viewport. If such a manipulation is desired, the process involves two basic pointer-based (or “mouse based”) motions/actions: a “drag” action (to center the subject within the viewport), and a “shrink” action (to reduce the size of the entire imported image). Either of these actions may be performed or repeated in any order: the goal is to properly center and size the desired portion of the image within the viewport, and then accept the visible sub-section of the image.

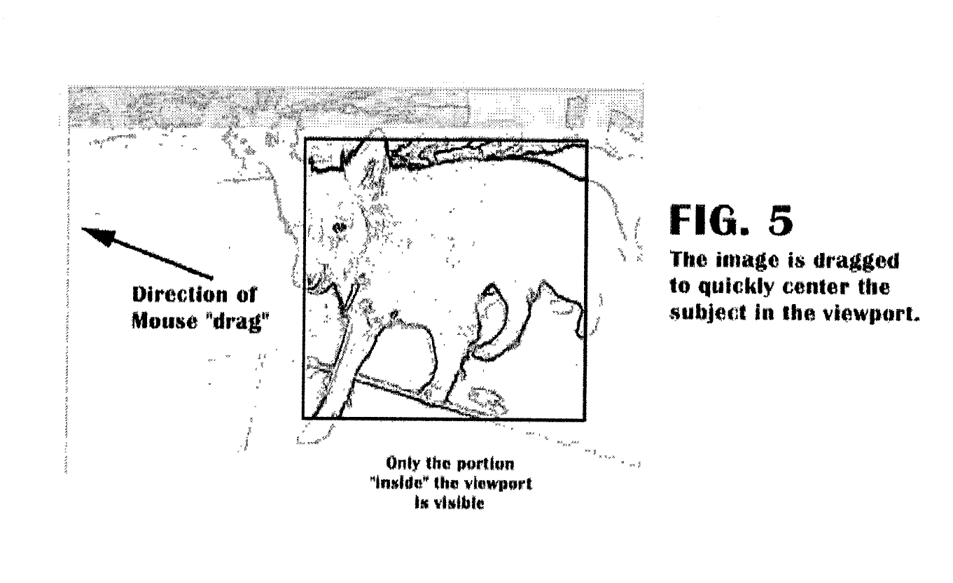

The “drag” action consists of clicking—and holding—the mouse down on the image, and then “dragging” the mouse. When this action is performed, the software moves the image located within the viewport in the same direction as the mouse. The user continues to “drag” the image within the viewport until the subject within the image becomes “centered” within the vie port. Refer to FIG. 5.

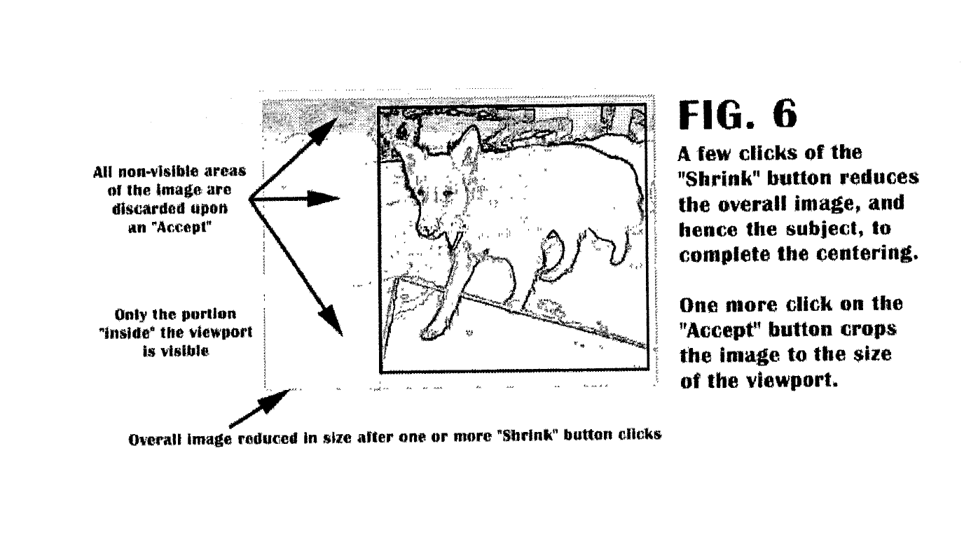

Once the desired subject item within the image becomes visible, the user may opt to perform a “shrink” action. Clicking the “shrink” button on the interface performs this action. The “shrink” action reduces the entire imported image by a small percentage. Each additional click of the “shrink” button further reduces the image by a small percentage. Refer to FIG. 6

By combining the “drag” and “shrink” actions (in no specific order), one may perfectly position and/or size the subject of a digital image in the viewport within seconds, while maintaining the same overall height to width ratio.

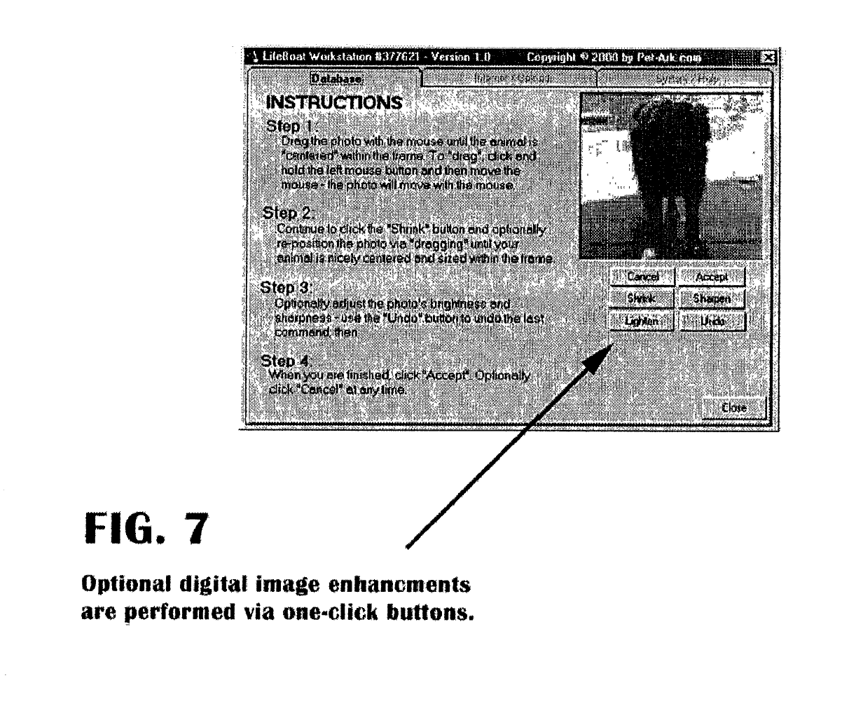

After the subject is appropriately positioned and/or sized, the user may opt to fine time the image via additional user interface buttons. These buttons include basic digital image manipulation methods such as “sharpen”, “lighten”, “darken”, etc. (FIG. 7).

When the user is finished with the fine-tuning process, they may then press yet another button on the interface—an “accept” button. Again, the term “accept” here implies that a new digital image will be created and saved, where the “new image” is comprised of only the visible portion of the image loaded inside the viewport. (FIG. 6 and FIG. 7).

The invention also provides an option to “auto-crop” and “auto-manipulate” each selected digital image if so desired. This method is achieved by first placing a selected image within the viewport, and then automatically proportionally resizing the entire image such that it becomes as small as possible, while still being at least as high and at least as wide as the viewport. After the resize operation is complete, the image is automatically “accepted”.

The entire process, therefore, includes the following steps. The user:

1. imports or captures a digital image of the item via a button on the software interface

2. optionally centers the “subject” within the viewport via “drag” and/or “shrink” action{s}

3. optionally further enhances the image (sharpen, lighten, etc.), then

4. crops the image via clicking on the “Accept” button, which then creates the visible sub-section of the image as a new image, OR

5. chooses to bypass the “by hand” image manipulation process of (2) through (4) and instead have the software application “auto-manipulate”, “auto-crop”, and “auto-save” the selected image{s}.

A Mechanism To Inform The Database To Alternatively Use A Pre-Existing “Default Image” For The Item In Question

This component of the invention allows a person to optionally bypass the entire digital image import and manipulation process and instead indicate that the item in question can be represented by a preexisting “default image” that is already located within the database. This component may be viewed and executed as an integral part of the entire invention, or it may exist as a separate component since it has the capability of being applied to similar related computer applications.

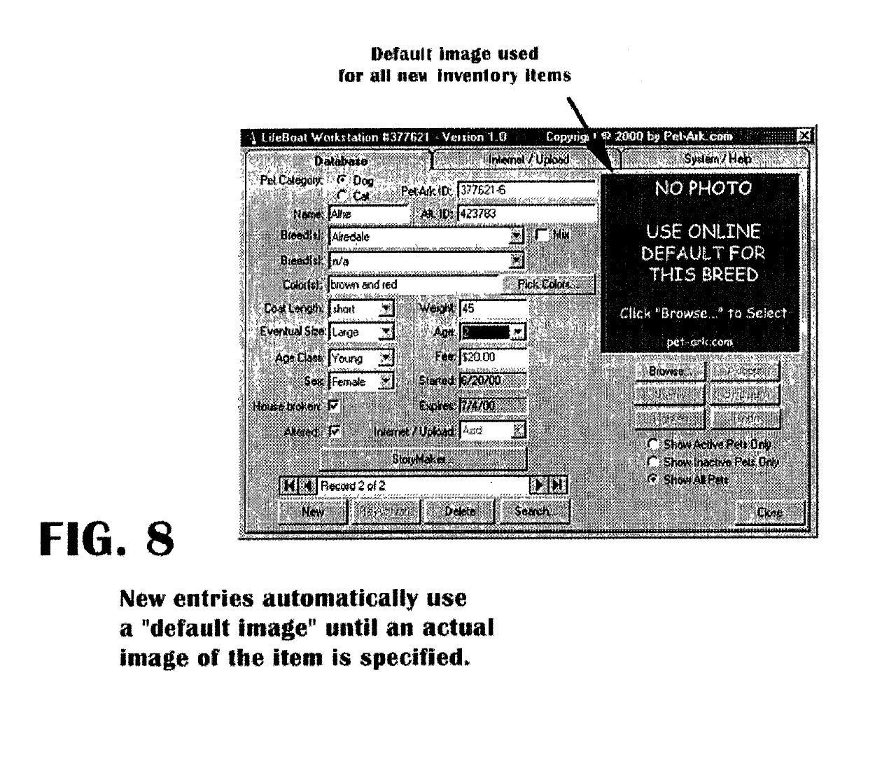

The software accomplishes this method by automatically displaying a “default image” in the software viewport when any new item data entry session begins. This initial default digital image is generic in nature and is used for all new items (FIG. 8).

If the user chooses not to import I capture and manipulate a digital image of the inventory item being entered, then the software will notify the database to use the existing “default image” for this item. However, if the user does import and manipulate a digital image, then this image will be transferred to the database for inclusion when an update action is performed.

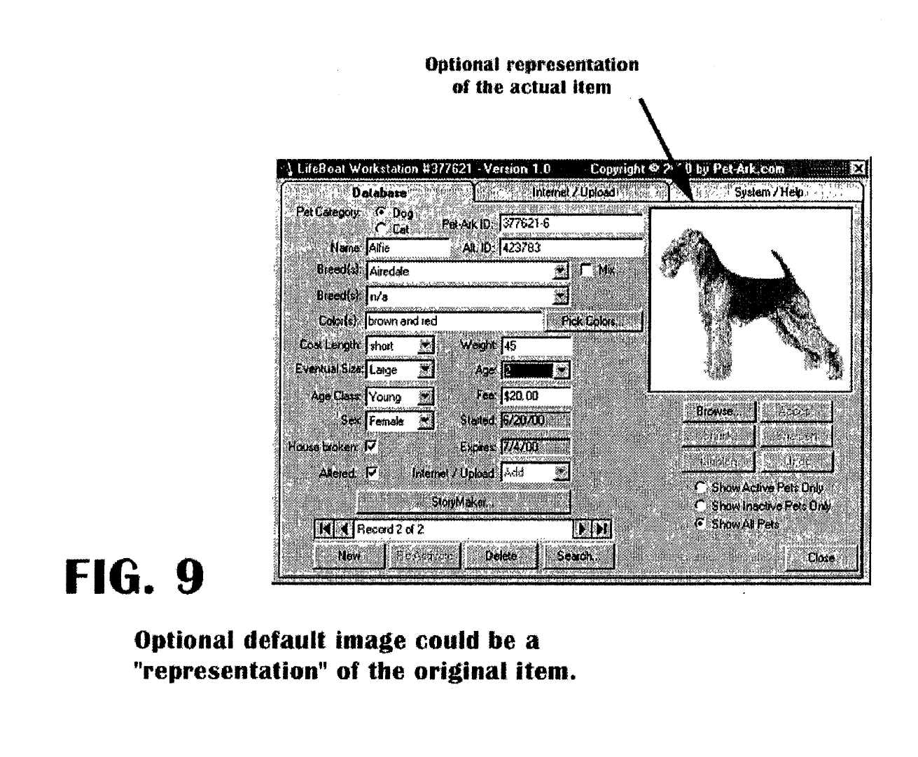

The software may also provide an alternative default digital image for any item that is chosen to use a default image. This alternative digital image is nothing more than a duplicate image of the same pre-existing “default image” that exists within the database. The duplicate image is selected and displayed within the viewport based on user input criteria. For example, if the inventory item was an Airedale Terrier, the default image could be a “stock image” of an Airedale. It would not however, be the image of the actual Airedale entered (FIG. 9).

“Story Generation” based off of Data Entry & Simple Input Options

This component of the invention generates one or more descriptive paragraphs about an item contained in a database without ever typing in anything “by hand”. The sentences generated are unique and specific to the item in question. In other words, they are not simply pre-constructed sentences, but rather sentences and phrases that are constructed in real time in response to data that already exists or is being entered into the database. The sentence structure and order may also be randomized, thus providing individuality to each “story” generated. Finally, a re-generation of the story is possible based off of a prior generated story. This component may be viewed and executed as an integral part of the entire invention, or it may exist as a separate component since it has the capability of being applied to similar related computer applications.

The software accomplishes this method by creating unique descriptive phrases based off of two distinct methods of generation:

via pre-constructed sentences that contain variables that correspond to database fields, database field names, and/or interface components, and

via execution one or more short “tailored algorithms” that create a grammatically correct phrase based off specific database fields, database field names, and/or interface components.

For example purposes, assume there exists a database containing pets, and inside this database, there exists the fields of name, color, breed, gender, and age. Further assume that the values for these fields are “Toby”, “black”, “Labrador Retriever”, “neutered”, and “9 weeks”, respectively.

To demonstrate the first method of generation listed above, assume the following pre-constructed sentence: “[name] is a [gender] [color] [breed] that is [age] old, and is currently looking for a really good home”.

During generation, each variable (such as [name]) is replaced with the corresponding database field value (“Toby”). Although some of the variable replacements may include capitalization manipulation, for the most part one can see it's a straightforward substitution. The final resultant sentence constructed from the example would look like this: “Toby is a neutered black labrador retriever that is 9 weeks old, and is currently looking for a really good home”.

Generation may also be constructed via “tailored algorithms” that count, evaluate, or analyze certain field values, field names, and/or interface components. For example, a simple algorithm could analyze the gender field, and produce pronouns based off the value of this field (example: “Toby is a neutered black labrador retriever that is 9 weeks old, and he is currently looking for a really good home”).

For another “tailored algorithm” example, assume that there exist some objects that are either

a series of Boolean fields within the example database, that contain the following field names: playful, happy, barks a lot, loves to run, digs, and is great with kids, or

a series of checkboxes ( or interface components) within the interface, that contain the following captions: playful, happy, barks a lot, loves to run, digs, and is great with kids.

Further assume that the “tailored algorithm” counts the number of “true” settings of these objects, and then creates one or more phrases based off of the count and their corresponding field name or caption, respectively.

The short “tailored algorithm” might look like this:

If more than 1 objects true: randomize their order, labeling the randomized results as ¢item1” through “itemX”, then use the following formula for generation:

If 1 object is true, “[name] is [item].”

If 2 objects are true: “[name] is [item1} and [item2].”

If 3 objects are true: “[name] is [item1], [item2], and [item3].”

If 4 objects are true: “[name] is [item1], [item2], and [item3]. [Gender-Pronoun] also is [item4].

Some outputs from such a “tailored algorithm” might look something like this:

if only 1 object is true: “Toby is playful.”

if 2 objects are true: “Toby is playful and loves to run.”

If 3 objects are true: “Toby is playful, happy, and loves to run.”

if 4 objects are true: “Toby is happy, playful, and loves to run. He also is great with kids.”

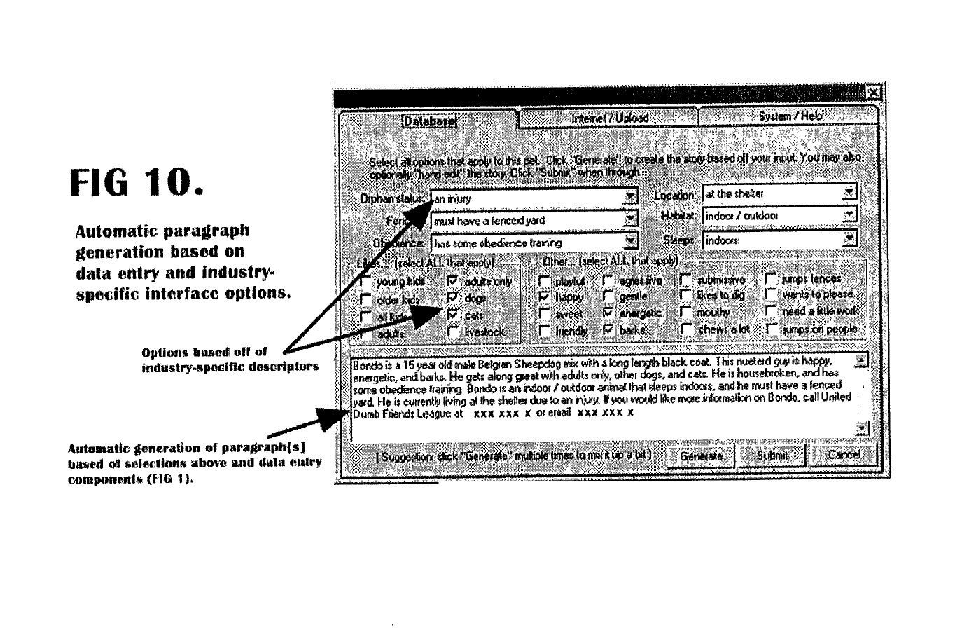

Note that the above “tailored algorithm” used database field values ([name] and [gender]), database field names, and/or interface component captions or phrases. Only the interface components—such as drop-down boxes, radio buttons, and/or checkboxes—are not contained within a database, which means that their values are stored only within the story. (FIG. 10). Furthermore, if interface components are used to “flavor” the story, they may be designed such as to provide flexibility to their caption or phrase. Using the pet “behaviors” as an example, suppose one interface component is “loves the mountains”. This caption may be fine for dogs in Colorado [for example], but maybe not for dogs in Florida. By allowing a user to semi-customize certain interface component captions and phrases allows a person in Florida—for example—to opt to change “loves the mountains” to “loves the beach”. Notice that after the change is made, the tailored algorithm still applies and a grammatically correct sentence is generated using the new value for the interface component.

Similar sentences can be generated for other inventory items such as homes or cars. In this case, instead of behaviors, it might be room descriptions (“This home has 4 bedrooms, a large master suite, 3 baths, and one half bath. It is only 1 year old and has a nice big backyard—perfect for entertaining.”) or car descriptions (“This immaculate 4×4 truck has dual exhaust, custom wheels, a towing package, and is in great shape.”).

Assuming all database fields for a particular item exist, the automatic generation of one or more unique descriptive paragraphs about the item may be performed by pressing a “Generate” button on the software interface. Alternatively, the descriptive paragraphs may be auto-generated as each interface component and/or database field is selected, entered, or modified. Regardless, if the user presses the “Generate” button again, the paragraph sentence-order and/or structure is modified and reordered to provide individuality to the “story”. When the operator is satisfied with generated information, they may press an “Accept” button on the interface to assign the computer-generated story to the inventory item.

The application also allows one to edit an existing story. For all non-database field values (such as with the “behaviors” example above), the software can automatically preset specific interface components based off of the existing story, prior to the editing session. It does this by scanning the existing auto-generated sentences, and recognizing keywords within the each sentence (like “playful” or “needs a little work”). When the software finds a keyword or key phrase, it can set the appropriate interface component that contains the keyword prior to the editing session. In other words, all user interface components that were selected to generate the story are reset to their corresponding correct values prior to an editing session, thus providing for a quick and easy editing/updating session with minimal effort.

Finally, the software also allows the one to optionally “hand-edit” any one of the computer-generated paragraphs after generation to allow insertion of additional information and/or to provide a “personal touch” to the computer-generated information.

The entire process, therefore, includes some or all of the following steps:

1. the data entry or data import section of the inventory item is completed, which may automatically trigger the computer-generated “story” process

2. additional industry-specific interface components that further describe the item in question are optionally selected, which may possibly begin displaying the computer generated “story”

3. a Generate button on the interface is optionally clicked to computer-generate one or more descriptive paragraphs about the item based off the data in the database fields and/or interface component settings

4. the Generate button is optionally clicked again [and again] to randomize the sentence ordering and structure, and hence the presentation of the information

5. the generated story is optionally edited by hand-edit to add an optional personal touch to the computer-generated data

6. the story is “accepted” and is either displayed or saved in the database

7. the process may be re-entered at a later time to re-compose and/or edit the descriptive data without having to reset the interface components to the correct values to regenerate the paragraphs.

Updating a Database on a Central Server with “just one click” or via a timer

This component of the invention allows any person to update a database with “just one click” or via a timer.

The “click” involves a simple press of a button on the software application interface. The data entry person performs this click when they are ready to update the database with the new information entered. This component may be viewed and executed as an integral part of the entire invention, or it may exist as a separate component since it has the capability of being applied to similar related computer applications.

When the one-click updating process initiates, the software application determines what information needs to be relayed to the database. After this determination, it creates information packets. If the computer workstation is currently offline, it then automatically connects to the central server. The information packets are then relayed to the database. Once the packets are relayed, the updating process at the workstation is considered complete, and the computer may optionally disconnect and go back to an offline state.

The new information packets are then processed by the database. New items are added to the database. Modified items will be updated, and deleted items are removed from the database.

The timer component works exactly as the “one click” mechanism, except that it is automatically initiated after a specific interval has passed.

Example Application of the Invention

The discussion to follow illustrates how the invention might be applied to an existing industry. The example will use an online “Animal Rescue/Shelter” (ARS) that lists pets in need of adoption located in shelters nationwide as the industry case-in-point.

This ARS example parallels the online automobile, real estate, and similar industries, since each of these industries contain similar characteristics with respect to the online database and data entry process. These characteristics include the following:

1. both photos and text are required components of an inventory “item” if they are to be listed in an online database

2. one or more descriptive paragraphs pertaining to the item must be created

3. inventory changes rapidly over a short period of time

4. the inventory if “items” is distributed over a wide range of locations and area

Specific to a nationwide online ARS, additional characteristics may include:

1. workers that are usually volunteers, and may—or may not—contain computer skills

2. severe time constraints, since much of the time is spent taking care of animals

Without the Invention

Without the invention disclosed in this document, the current method for updating an online database with pet information is archaic, unrestricted, difficult, vulnerable, and very time consuming.

For example, if the data entry person opts to manipulate the original digital image of the animal, this manipulation must be performed by a third party software application that expects a certain range of skill and computer knowledge. It also doesn't guarantee that the image will be optimized for online display purposes. If the data entry person opts to bypass the digital image manipulation process or send the digital image “as is”—the online database image components becomes non-uniform and unpredictable.

Furthermore, the data entry person must have creative and verbal skills in order to create the descriptive paragraph of the animal “by hand”. Research in the ARS industry indicates that this component alone is a real “show stopper”. Volunteers and/or employees have expressed an extreme distaste for the “story creation process”, as it is not only very time consuming, but also very difficult to perform.

Other inherent issues include requiring the user to be online to perform the update, which also leaves open the possibility of losing the entire data entry session for the animal if the online connection becomes lost. The online requirement also makes it impossible—for example—to edit, modify and/or add data offline on a computer that does not have an Internet connection.

Furthermore, if the operator/data entry person is curious as to the current online status of a given animal, they must log onto the online database and perform a search, and then wait for the online database to return the status of the animal if found.

With the Invention

With the invention disclosed in this document, the current method for updating an online database with pet information is optimized, efficient, easy, and standardized.

For example, the data entry person may select and manipulate the original digital image of the animal within seconds and without any prior skill or computer knowledge. This manipulation also guarantees that the image will be optimized for online display purposes. They may also bypass this portion of data entry completely and alternatively specify that the online database use a “default image” for the pet (e.g., a default picture of a collie if the dog is a collie). Either way, the digital image process is expedited and the digital image made uniform.

Furthermore, the data entry person can create the descriptive paragraph of the animal without any creative and/or verbal skills, and in seconds. This removes the dreaded “show stopper” scenario as described in the prior section: volunteers are actually amazed at the speed and ease of the computer-generated paragraphs, and enjoy selecting the parameters that the computer uses to base the story.

The invention also allows the computer used for data entry to remain offline during the data entry process. This means—for example—that a volunteer could perform the data entry process “in the trenches” (in the ARS case, the “cage area” or in the “exercise area” of the shelter) on an off-line laptop. They could also then take this laptop home with them and/or work on the data while in transit on a bus or airplane. This makes it easier to get the job done over time, and it also makes it easier for the volunteer performing the data entry duties. It also eliminates the possibility of data loss through a disconnected online session.

Finally, the operator/data entry person knows the exact state of each of the animals they have submitted to the online database—without going online to determine their status. They know when they inserted the animal, when the animal is due for possibly automatic expiration, and/or whether or not the animal is in a suspended mode. “Suspended” in the case of ARS could mean that someone has shown interest in the animal and they wanted the shelter to “hold” the animal for a day or two.

1. A computer system for preparing a digital image, comprising:
computer processing means;
window means for viewing the digital image;
means for positioning the image within said window means;
means for shrinking or enlarging said image to alter its fit within said viewing window means;
means for saving to storage the portion of the image appearing in said window means.

2. In a computer system having a monitor, a CPU, and a pointing device, a method for preparing a digital image, comprising the steps of:
(a) providing a viewport window for viewing the digital image on said computer monitor, said viewport having a fixed height and width;
(b) importing said image into said viewport;
(c) comparing the height and width of said image to the height and width of said viewport, and if either the height or width dimension of said image is smaller than the corresponding dimension of said viewport, automatically enlarging said image proportionately such that both the height and width of the image are equal to or greater than the corresponding viewport dimension;
(d) if the image is positioned and sized within the viewport as desired by the user, go to step (j);
(e) comparing the height and width of said image to the height and width of said viewport, and if either the height or width of said image is greater than the corresponding dimension of said viewport, selectively positioning said image within said viewport by dragging said image into position with a click-and-drag operation of said pointing device;
(f) if the image is positioned and sized within the viewport as desired by the user, go to step (j);
(g) if both the height and width of said image are larger than the corresponding viewport dimensions, proportionately shrinking the entire image by a small percentage, but never shrinking said image such that either the height or width of the image becomes less than the respective height or width of the viewport;
(h) if the image is positioned and sized within the viewport as desired by the user, go to step (j)
(i) repeating steps (e) through (h) in any order or combination until the image is positioned and sized within the viewport as desired by the user; and
(j) entering an “accept” command into the computer to crop the image to eliminate any portion of the image lying outside the viewport and save the portion of the image displayed in the viewport as a new image:

3. In a computer system having a monitor, a CPU, and a pointing device, a method for preparing a digital image, comprising the steps of:
(a) providing a viewport window for viewing the digital image on said computer monitor, said viewport having a fixed height and width;
(b) importing said image into said viewport;
(c) comparing the height and width of said image to the height and width of said viewport, and performing one of the following steps:
i. if either the height or width dimension of said image is smaller than the corresponding dimension of said viewport, automatically enlarging said image proportionally such that both the height and width of the image are equal to or greater than the corresponding viewport dimension;
ii. if the height or width of said image is larger than the corresponding viewport dimensions, automatically proportionately shrink the entire image until at least one of the dimensions is equal to the corresponding dimension of said viewport;
iii. if the height and width of said image are the same as the corresponding viewport dimensions, do nothing;
(d) automatically generating an “accept” command into the computer to crop the image to eliminate any portion of the image lying outside the viewport and save the portion of the image displayed in the viewport as a new image.

4. A computer system for generating sentences about a selected item contained in a computer database, comprising:
computer processing means having access to said database;
means for entering and storing data within said computer processing means; and
means for generating at least one sentence from said data;

5. A computer system for generating sentences as claimed in claim 4, further including:
means for placing a plurality of said sentences into order to form a narrative story.

6. A computer system for generating sentences as claimed in claim 5, further including:
means for editing said story.

7. A computer system for generating sentences as claimed in claim 5, further including:
means for altering the order of said sentences in said narrative story.

8. A method for generating sentences about an item contained in a computer database, comprising the steps of:
(a) providing at least one of the following:
(i) pre-defined sentences containing variables corresponding to field names or field values in the database; and
(ii) tailored algorithms for counting, evaluating, or analyzing certain field values;
(b) providing data contained within said fields in said database by:
(i) entering said data into the database, or
(ii) accessing existing data from said database; and
(c) generating one or more descriptive sentences based upon said data.

9. A method for generating sentences as claimed in claim 8, wherein said sentences are placed into order in a narrative story.

10. The method for generating a narrative story as claimed in claim 9, further including the steps of:
(d) providing interface components containing captions or phrases;
(e) providing at least one of the following:
(i) pre-defined sentences containing variables corresponding to captions or phrases of selected interface components; and
(ii) tailored algorithms for counting, evaluating, or analyzing certain interface component settings;
(f) providing user access to said interface components; and
(g) generating at least one descriptive sentence based upon said interaction with said interface components.

11. The method for generating a narrative story as claimed in claim 9, wherein said descriptive sentences are generated in response to a “generate” command.

12. The method for generating a narrative story as claimed in claim 9, further including the steps of:
(h) providing the capability of editing the narrative story manually; and
(i) entering an “accept” command to save the edited version of the story.

13. The method for generating a narrative story as claimed in claim 9, wherein re-entering the “generate” command will alter said narrative order of said sentences.

14. The method for generating a narrative story as claimed in claim 12, further including the step of
(j) allowing the user the option to re-open the saved version of the story to further edit the story.

15. The method for generating a narrative story as claimed in claim 12, wherein said editing may be accomplished by any combination of the following steps:
(a) manually typing changes into the story;
(b) changing field values in the database; and
(c) modifying interface component values.
